(19) United States
(12) Patent Application Publication
(10) Pub. No.: US 2004/0134130 A1
(43) Pub. Date: Jul. 15, 2004

(54) Window regulator cable assemblies

(76) Inventors: Simon B. Dobson, Sandgate (GB); Jurgen F. Moser, Braunschweig (DE)

Correspondence Address: CARLSON, GASKEY & OLDS, P.C., 400 WEST MAPLE ROAD, SUITE 350, BIRMINGHAM, MI, 48009, US

(21) Appl. No.: 10/717,988

(22) Filed: Nov. 20, 2003

(30) Foreign Application Priority Data
Nov. 20, 2002 (GB) 0227055.1

(51) Int. Cl. E05F 15/08

(52) U.S. Cl. 49/352; 49/349; 49/348; 49/374

(57) ABSTRACT

A window regulator cable assembly method and system includes a window regulator cable arrangement having a cable drum wheel, a first top pulley wheel, a first bottom pulley wheel, and a cable. The cable drum wheel, the top pulley wheel and the bottom pulley wheel are in a spaced apart relationship. The cable is mounted to provide cable runs between the wheels. At least one wheel is spaced from another wheel by a semi-rigid tube that surrounds the associated cable run. The semi-rigid tube is under an axial load to maintain tension in the cable. The wheels are pivotally mounted in a rigid spaced apart relationship on a rigid frame to remove the axial load from the semi-rigid tube.

### REFERENCE TO RELATED APPLICATIONS

This patent application claims priority to GB 0227055.1 filed on Nov. 20, 2003.

### TECHNICAL FIELD OF THE INVENTION

The present invention relates generally to a window regulator cable assembly for a vehicle door having a removable semi-rigid tube on the cable runs.

### BACKGROUND OF THE INVENTION

The present invention is particularly applicable to vehicle doors. Vehicles include vehicle doors having a window glass which can be lowered to an open position or raised to a closed position. The raising or lowering of the window glass is achieved by a window regulator. In one known geared window regulator, a relatively small pinion gear is turned to engage a geared sector having an arm, attached to the bottom of the window glass.

Another window regulator is a cable-type window regulator that includes a cable arrangement wound around a cable drum and a variety of cable pulleys. A cursor is connected to the cable arrangement, and rotation of the cable drum lifts or lowers the cursor. The cursor is connected (either directly or indirectly) to the lower edge of a window glass. Thus, lifting or lowering of the cursor correspondingly lifts or lowers the window glass.

“Single lift” cable arrangements are known (shown in FIG. 1 or FIG. 2). “Dual lift” cable arrangements of various types are also known. Cable arrangements (either the single or dual lift type) fall into two broad categories, namely bare cable arrangements and Bowden cable arrangements.

Further examples of Bowden cable type window regulator assemblies are disclosed in U.S. Pat. No. 5,694,717, EP0107531, EP0385167, EP0607589 and GB1448795. EP0607589, U.S. Pat. No. 5,694,717, EP0107531 and GB1448795 all describe systems for tensioning the inner cable. EP0607589, U.S. Pat. No. 5694717 and EP0107531 disclose systems that include a helically wound spring which tensions the inner cable by reacting against the Bowden cable sheath. Thus, the tensile load in the cable equals the compressive load in the spring, which in turn equals the compressive load in the cable sheath.

An object of the present invention is to provide an improved window regulator cable assembly which is less expensive to produce than the prior art window regulator cable assembly.

### SUMMARY OF THE INVENTION

The present invention provides a method of providing a window regulator cable assembly. The method includes the steps of providing a subassembly including a cable drum wheel, a first top pulley wheel, a first bottom pulley wheel, and a cable arrangement. The cable drum wheel, the top pulley wheel and the bottom pulley wheel are in a spaced apart relationship, and the cable arrangement is mounted on the wheels to provide cable runs between the wheels. At least one wheel is spaced from another wheel by a semi-rigid tube that surrounds the associated cable run. The semi-rigid tube is subject to an axial load to maintain tension in the cable arrangement and provide a rigid frame. When the subassembly is mounted on the rigid frame, the semi-rigid tube is no longer subject to the axial load.

According to a further aspect of the present invention, a window regulator cable assembly includes a cable drum wheel, a first top pulley wheel, a first bottom pulley wheel, and a cable arrangement. The cable drum wheel, the top pulley wheel and the bottom pulley wheel are in a spaced apart relationship, and the cable arrangement is mounted on the wheels to provide cable runs between the wheels. At least one wheel is temporarily spaced from another wheel by a semi-rigid tube that surrounds the associated cable run to maintain an initial tension in the cable before assembly of the arrangement onto an associated rigid frame. The semi-rigid tube is made from an extruded plastic material, such as PVC or polyethylene.

According to a further aspect of the present invention, a window regulator cable assembly includes a cable drum wheel, a first top pulley wheel, a first bottom pulley wheel, and a cable arrangement. The cable drum wheel, the top pulley wheel and the bottom pulley wheel are in a spaced apart relationship, and the cable arrangement is mounted on the wheels to provide cable runs between the wheels. At least one wheel is temporarily spaced from another wheel by a semi-rigid tube that surrounds the associated cable run to maintain an initial tension in the cable before assembly of the arrangement onto an associated rigid frame. The semi-rigid tube includes a longitudinal slit that facilitates assembly of the semi-rigid tube on the cable run and that facilitates removal of the semi-rigid tube from the cable run.

According to a further aspect of the present invention, a window regulator cable assembly includes a cable drum wheel, a first top pulley wheel, a first bottom pulley wheel, and a cable arrangement. The cable drum wheel, the top pulley wheel and the bottom pulley wheel are in spaced apart relationship, and the cable arrangement is mounted on the wheels to provide cable runs between the wheels. At least one wheel is temporarily spaced from another wheel by a semi-rigid tube that surrounds the associated cable run to maintain an initial tension in the cable before assembly of the arrangement onto an associated rigid frame. A second cable run intersects the semi-rigid tube, and the semi-rigid tube prevents contact between the cable run and the second cable run.

According to a further aspect of the present invention, a window regulator cable assembly includes a cable drum wheel, a first top pulley wheel, a first bottom pulley wheel, and a cable arrangement. The cable drum wheel, the top pulley wheel and the bottom pulley wheel are in a spaced apart relationship, and the cable arrangement is mounted on the wheels to provide cable runs between the wheels. At least one wheel is temporarily spaced from another wheel by a semi-rigid tube that surrounds the associated cable run to maintain an initial tension in the cable arrangement before assembly of the arrangement onto an associated rigid frame. A cable tensioning system including a resiliently mounted deflector engages a portion of one of the cable runs to deflect the portion laterally, thereby increasing the effective length of the cable run.

According to a further aspect of the present invention, a window regulator cable assembly includes a cable drum wheel, a first top pulley wheel, a first bottom pulley wheel, and a cable arrangement. The cable drum wheel, the top pulley wheel and the bottom pulley wheel are in spaced apart relationship, and the cable arrangement is mounted on the wheels to provide cable runs between the wheels. At least one wheel is temporarily spaced from another wheel by a semi-rigid tube that surrounds the associated cable run to maintain an initial tension in the cable arrangement before assembly of the arrangement onto an associated rigid frame. At least one cable having an end defining a longitudinal direction is mounted in a cable end housing. The cable end is biased in the longitudinal direction by a resilient member, shortening the effective length of the cable to tension the cable arrangement.

These and other features of the present invention will be best understood from the following specification and drawings.

### BRIEF DESCRIPTION OF THE DRAWINGS

The invention will now be described, by way of example only, with reference to the accompanying drawings, in which:

FIG. 1 schematically illustrates a prior art bare cable single lift window regulator cable assembly;

FIG. 2 schematically illustrates a prior art Bowden cable single lift window regulator cable assembly;

FIG. 3 schematically illustrates a single lift window regulator cable assembly according to the present invention;

FIG. 4 schematically illustrates a dual lift window regulator cable assembly according to the present invention;

FIG. 5 schematically illustrates an alternative dual lift window regulator cable assembly according to the present invention;

FIG. 6 schematically illustrates a cross view of FIG. 3 taken along line B-B;

FIG. 7 schematically illustrates a view of a cursor used with the present invention; and

FIG. 8 schematically illustrates a partial view of a further embodiment according to the present invention.

### DETAILED DESCRIPTION OF THE PREFERRED EMBODIMENT

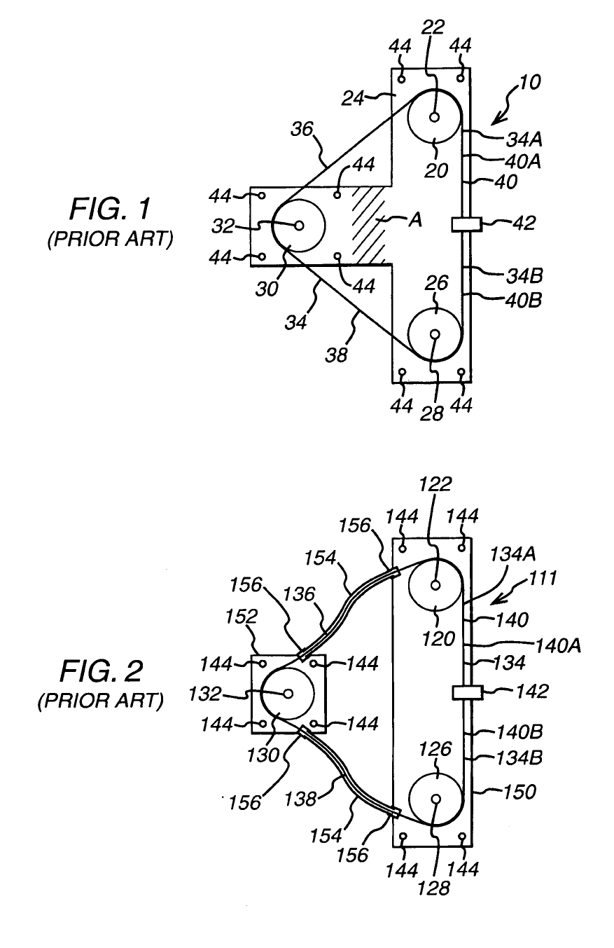

FIG. 1 schematically illustrates a single lift bare cable window regulator cable assembly 10. An upper pulley wheel 20 is pivotally mounted via an upper pivot 22 onto a rigid member 24. A lower pulley wheel 26 and a cable drum 30 are also pivotally mounted via a lower pivot 28 and a cable drum pivot 32, respectively, onto the rigid member 24. A cable arrangement 34 is wound around the wheels 20, 26, and 30, defining cable runs 36, 38 and 40. The cable run 40 includes a cursor 42 attached, either directly or indirectly, to the bottom of a window glass (not shown). The cable run 40 is therefore defined by a cable run 40A (between the upper pulley wheel 20 and cursor 42) and a cable run 40B (between the lower pulley wheel 26 and cursor 42). Rotation of the cable drum 30 in a clockwise direction lowers the cursor 42, and rotation of the cable drum 30 in a counter-clockwise direction raises the cursor 42.

Typically, the cable arrangement includes two separate cables 34A and 34B. One end of the cable 34A is attached to the cursor 42, and the other end of cable 34A is attached to the cable drum wheel 30. The end portion of cable 34A proximate to the cable drum wheel 30 is typically wound around the cable drum wheel 30 several times to allow for lifting and lowering of the cursor 42. In a similar manner, one end of cable 34B is attached to the cursor 42, and the other end of the cable 34B is attached to the cable drum wheel 30. Again, the end of the cable 34B proximate to the cable drum wheel 30 is wound around the cable drum wheel 30 several times to allow for lifting and lowering of the cursor 42. The cable 34A acts as a lifting cable, i.e., it acts in tension to lift the window glass, whereas the cable 34B acts as a lowering cable, i.e., it acts in tension to lower the window glass.

Typically, the components shown in FIG. 1 are a subassembly and are mounted into the door via fixing members, such as screws, bolts, rivets and the like, that pass through the fixing holes 44 and corresponding holes in the door. The window glass can then be fitted in the door.

The upper pulley wheel 20 and the lower pulley wheel 26 each include a circumferential groove that receives within which the cable. The cable drum wheel 30 includes a helical groove in its peripheral surface. The helical groove allows the cable 34A to wind onto and wind of the cable drum wheel 30 as the window glass is raised and lowered, respectively. A separate part of the helical groove allows for the lowering cable 34B to wind onto and wind off of the cable drum wheel 30 as the window glass is lowered and raised, respectively.

When the components of FIG. 1 are provided as a subassembly, the cable must remain sufficiently taut to ensure it does not come off any of the wheels 20, 26, and 30. Thus, the pulley wheel pivots 22, 26, and 32 must be fixed in the position shown. The rigid member 24 is typically made from sheet steel as a pressing, and the sheet thickness is approximately 0.6 mm thick. Once the subassembly is assembled into the door and secured firmly via the fixing holes 44, certain regions of the rigid member 36, such as the region shown as cross hatching at A, become redundant since the pivots 22, 26, and 32 for the wheels 20, 26, and 30 are held in their spaced apart relationship by the rigidity of the door.

FIG. 2 shows a single lift Bowden cable assembly 111, wherein the components which fulfill the same function as those of the cable assembly 10 are labeled with reference numerals 100 greater. Instead of a T-shaped rigid member 24, a rigid member 150 is provided onto which an upper pivot 122 and a lower pivot 128 are secured, ensuring that the upper and lower pulley wheels 120 and 126 are maintained in the spaced apart relationship.

The cable drum wheel 130 is provided on a separate plate 152. To ensure that the cable remains in the associated grooves of the wheels 120, 126, and 130, Bowden cable sheaths 154 are provided on the cable runs 136 and 138.

The Bowden cable sheaths 154 are flexible and typically include a tightly helically wound metal strip that form a tube. The inside of the tube is lined with a friction reducing material, such as PTFE, and the outside of the tube is protected by a waterproof material, such as a plastics material. The ends of the Bowden cable sheath 154 engage with fittings 156 of the rigid member 150 and the plate 152. The fittings 156 are sufficiently strong to support a load equivalent to the maximum tensile load in the cable (since the fittings 156 react against this load). Furthermore, the tensile load in the cable is reacted as an exact equivalent compressive load (ignoring any friction effects) in the Bowden cable. The Bowden cable is sufficiently strong to support a compressive load equivalent to the maximum tensile load in the cable. Therefore, an elaborate, and therefore expensive, tightly helically wound metal strip, friction-reducing lining and waterproof outer material is required.

The Bowden cable sheath 154 is flexible, and the ends of a particular Bowden cable sheath can move relative to each other. That is, by bending the Bowden cable sheath 154 into a U-shape, the ends of the sheath 154 approach each other. By straightening out the sheath 154, the ends of the sheath 154 move apart. Therefore, the straight line distance between the ends of the sheath 154 can be vary. In certain installations, this feature can be used to move the plate 152 closer to the rigid member 150 to avoid obstructions when assembling the window regulator cable assembly 111 into its respective door. Once the obstruction has been avoided, the separate plate 152 and the rigid member 150 can be returned to their correct relative position and secured to the door. Therefore, the use of Bowden cables assists in assembling window regulator cable assemblies into doors and ensure that the cables remain in the correct grooves in the various pulley wheels.

The prior art system shown in FIG. 1 includes redundant material, and the prior art shown in FIG. 2 includes an expensive Bowden cable sheath 154 that requires relatively strong fittings on the rigid member 124 and the plate 152.

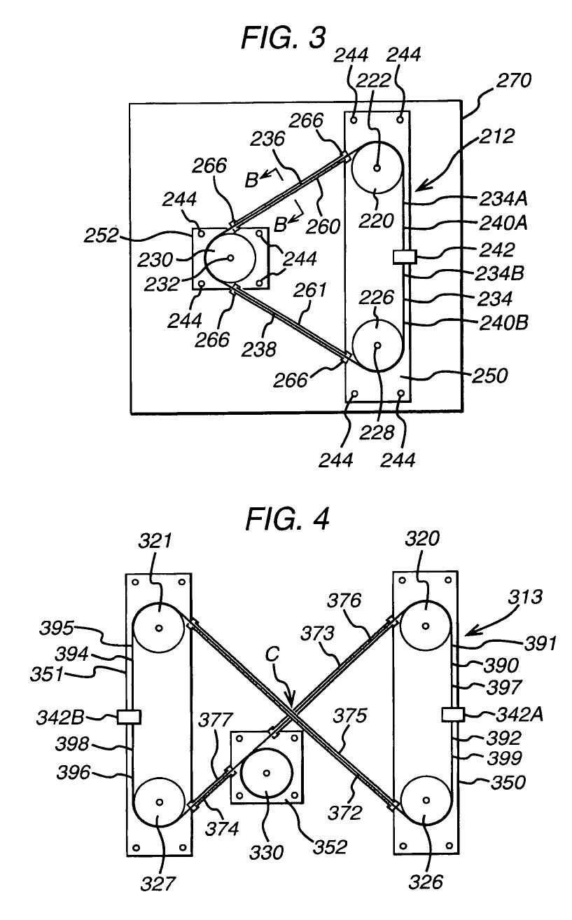

FIG. 3 shows a window regulator cable assembly 212 according to one embodiment of the present invention. The components fulfill substantially the same function as those shown in FIG. 1 and are labeled with reference numerals 200 greater. The upper and lower pulley wheels 220 and 226 are mounted on a rigid member 250 similar to the rigid member 150 of FIG. 2. Similarly, the cable drum wheel 230 is mounted on a separate plate 252 similar to the plate 152 of FIG. 2.

FIG. 3 further schematically shows a rigid frame 270 upon which the rigid member 250 and the separate plate 252 are secured via the respective fixing holes 244. The rigid frame 270 can be a door. Once the cable assembly 212 is secured to the door 270, the rigidity of the door 270 ensures that the rigid member 250 is correctly spaced apart from the separate plate 252.

The cable run 236 is surrounded by a semi-rigid tube 260. In one example, the semi-rigid tube is made from an extruded plastic material, such as PVC or polyethylene. The semi-rigid tube 260 has a longitudinal slit 262 (shown in FIG. 6). A semi-rigid tube 261 identical to the semi-rigid tube 260 surrounds the cable run 238. The internal diameter of the semi-rigid tube 260 provides a running fit on the cable 234. In this example, the internal diameter of the semi-rigid tube 260 is approximately 4 mm, and the external diameter of the semi-rigid tube 260 is approximately 6 mm. The ends of the semi-rigid tube 260 abut the fittings 266.

The semi-rigid tubes 260 and 261 temporarily space the cable drum wheel 230 from the upper and lower wheels 220 and 226, respectively. Thus, it is possible to manufacture the cable assembly 212, i.e., all of the components shown in FIG. 3 other than the door 270, as a subassembly. This subassembly can be transported and fitted to the door 270, and the semi-rigid tubes 260 and 261 ensure that the cable does not come out of any of the cable grooves in any of the wheels 220, 226, and 230. Once the subassembly is fitted to the door 270, the semi-rigid tubes 260 and 261 become redundant since the rigid member 250 is kept in its spaced apart relationship relative to the plate 252 by virtue of the rigidity of the door 270.

FIGS. 1, 2 and 3 provide a subassembly which ensures that the cable is under tension and does not become disengaged from the cable drum or the pulley wheels before assembly onto a door or the like. The redundant material shown cross hatched as A of FIG. 1 is not present in FIG. 3, allowing the embodiment shown in FIG. 3 to be lighter than the embodiment shown in FIG. 1. The expensive Bowden cable sheaths 154 of FIG. 2 are also not present in FIG. 3. The semi-rigid tubes 260 and 261 of FIG. 3 are less expensive to produce. Additionally, the fittings 156 of FIG. 2 must be sufficiently strong to react against the full cable tension load. The fittings 266 of FIG. 3 are only required to be strong enough to support “transportation” loads before the assembly of the cable assembly onto the door, and are significantly less than “in service” loads that occur when the cable assembly is mounted on the door 270 and the associated vehicle is in use.

The semi-rigid tubes 260 and 261 each have a longitudinal slit 262, allowing the semi-rigid tubes 260 and 261 to be removed from their associated cable runs 236 and 238 once the subassembly has been fitted to the door 270. Additionally, depending on the assembly method used, the longitudinal slit 262 can facilitate assembly of the tubes 260 and 261 onto the cable runs 236 and 238 during manufacture of the subassembly and before transportation of the subassembly.

In another embodiment, the longitudinal slit 262 is not required and the semi-rigid tubes 260 and 261 remain on their associated cable runs 236 and 238 in use. The semi-rigid tubes 260 and 261 are effectively redundant (except when two cable paths cross and when using bent tubes) since the semi-rigid tubes 236 and 238 are not required to maintain tension in the cable arrangement. To reduce costs, the semi-rigid tubes 236 and 238 are made out of an extruded plastic material.

The semi-rigid tubes 260 and 261 should be sufficiently rigid in a longitudinal sense to cope with the “transportation” loads. In most embodiments, the semi-rigid tubes 236 and 238 are semi-rigid in a lateral sense. Therefore, the ends of the semi-rigid tubes 236 and 238 remain at substantially the same distance from each other, unlike the ends of the prior art Bowden cable sheaths.

FIG. 4 shows a dual lift cable assembly 313 including components that fulfill substantially the same function as those of the cable assembly 10 and are labeled 300 greater. In this embodiment, there are two rigid members 350 and 351 spaced apart laterally. The rigid member 351 includes a second upper pulley wheel 321 and a second lower pulley wheel 327. The cable run 390 includes a cable run 391 extending from the pulley wheel 320 to the cursor 342A and a cable run 392 extending from the cursor 342A to the pulley wheel 326. The cable run 394 includes a cable run 395 from the cursor 342B to the pulley wheel 321 and a cable run 396 from the cursor 342B to the pulley wheel 327.

The cable arrangement includes three cables 397, 398 and 399. The cable 397 is similar to the cable 234A, and one end of the cable 397 is connected to the cursor 342A, and the other end of the cable 397 is connected to the cable drum wheel 330. The cable 397 is a lifting cable. The cable 398 is similar to the cable 234B, and one end of the cable 398 is connected to the cursor 342B and the other end of the cable 398 is connected to the cable drum wheel 330. The cable 398 is a lowering cable.

The cable 399 is connected at one end to the cursor 342B and at the other end to the cursor 342A. The cable 399 is an intermediate cable and acts in a lifting sense by lifting the cursor 342B, and also acts in a lowering sense by lowering the cursor 342A. There are three cable runs 372, 373 and 374, which include semi-rigid tubes 375, 376 and 377, respectively. The cable run 372 intersects the cable run 376 at point C, and any contact between the cable runs 372 and 376 is prevented by the semi-rigid tubes 375 and 376.

Once assembled onto the door, the three semi-rigid tubes 375, 376 and 377 can be removed to lighten the assembly and reused. However, the semi-rigid tubes 375, 376 and 378 are inexpensive and light weight and can remain on the assembly if preferred. In particular, where two cable runs 372 and 376 intersect, it is advantageous to leave at least one semi-rigid tube on the respective cable run to ensure the cable runs 372 and 376 do not contact and damage each other as a result of “sawing” action as the regulator is operated in use.

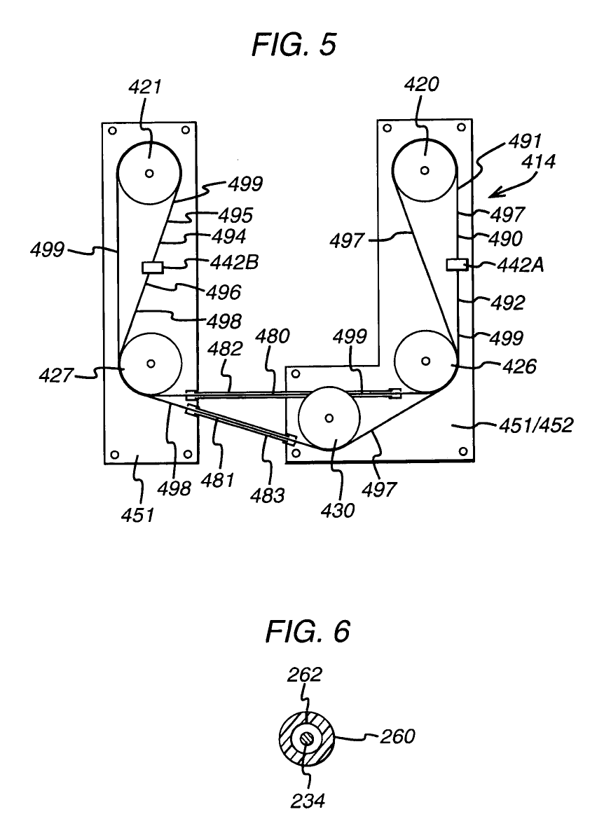

FIG. 5 shows another embodiment of a dual lift window regulator cable assembly 414 including components that fulfill substantially the same function as those shown in cable assembly 313 and labeled 100 greater. The cable drum wheel 430 is mounted on a plate that has been incorporated into the rigid member 451. The lower pulley wheels 427 and 426 each include a pair of wheels that rotate in opposite directions. The cable runs 480 and 481 are provided with the semi-rigid tubes 482 and 483.

In other embodiments, certain end fittings can be dispensed. For example, the end fittings 266 of the plate 252 can be removed, and the semi-rigid tubes 260, 261 are extended to contact the cable drum 230. Once assembled onto the door, the semi-rigid tubes 260 and 261 can be removed to allow the cable drum 230 to rotate freely.

The cable runs 236, 238, 372, 373, 374, 480 and 481 are all straight. Therefore, the corresponding semi-rigid tubes are straight. In further embodiments, the semi-rigid tubes can be curved or bent to accommodate the curves associated with the curve of the window glass. A curved semi-rigid tube can also be provided when the associated cable run needs a bend or kink to avoid components within the door. Once assembled, the curved semi-rigid tube rests against the particular component and is laterally supported by that component. A cable tensioning system straightens and tightens the cable against the particular component, but the semi-rigid tube acts between the cable and the particular component to prevent sawing of the cable on the component. The semi-rigid tube is not required to withstand any longitudinal loads once installed in the door, but merely acts as a surface over which the cable can slide.

As a result of wear and stretching of the cables in use, it is sometimes necessary to include a cable tensioning system. Typically, the tensioning system operates to displace part of a cable run laterally and increase the effective length of the cable run. Alternatively, a tensioning system can shorten the effective length of the cable.

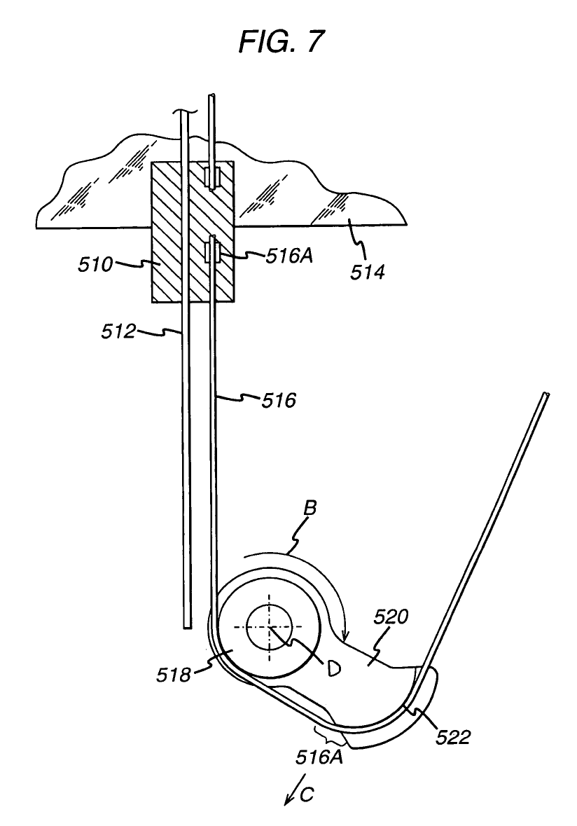

FIG. 7 shows a cable tensioning system for use with the present invention. A cursor 510 is slidingly mounted on a guide rail 512. A window glass 514 is attached to the cursor 510 by fixing members (not shown). An end 516A of the cable 516 is fixed to the cursor 510. A pulley wheel 518 and a displacer in the form of a lug 520 are pivotally mounted at pivot A. The lug 520 includes an arcuate guide slot 522 in which the cable 516 slides when the glass is lifted or lowered. The lug 520 is biased by a spring (not shown) in a clockwise direction as shown by arrow B. The pulley wheel 518 is pivoted at pivot D and can rotate independently of the lug 520. The biasing spring maintains tension in the cable 516. As the system wears, the lug 520 rotates slightly in the clockwise direction to take up any wear.

The arcuate guide slot 522 displaces a part of cable 516 laterally to cause an increase in length of the cable path. In this example, the region 516A is displaced laterally in the direction of arrow C.

The lug 520 can be associated with any of the pulley wheels or the cable drum wheels shown in FIGS. 3, 4 or 5. In other embodiments, a displacer can act partially along a cable run to displace that part of the cable laterally. In other embodiments, the pivot of a pulley wheel or the pivot of cable drum wheel can be biased to move the whole wheel as wear occurs to maintain tension in the cable. Under these circumstances, a region of the cable in contact with the wheel needs to be biased laterally.

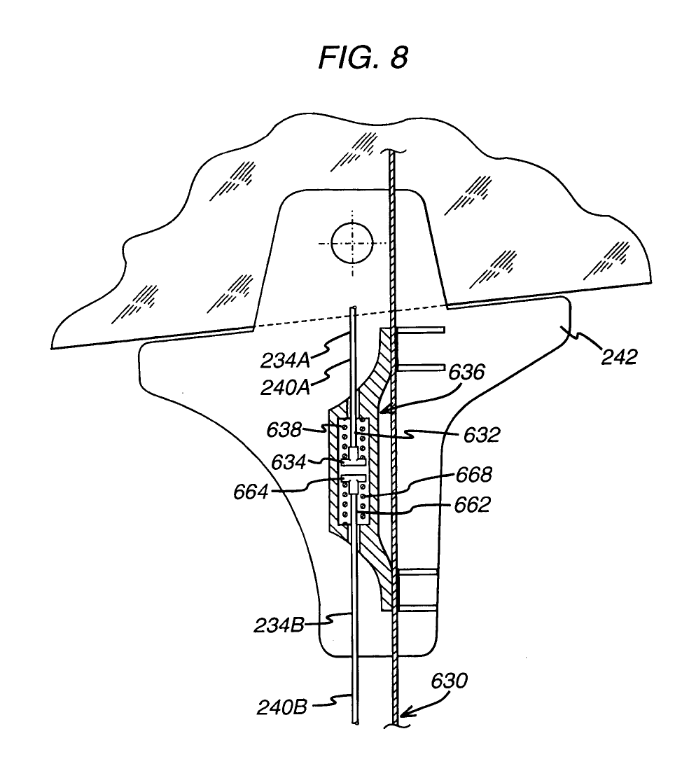

FIG. 8 shows a detailed view of the cursor 242 shown schematically in FIG. 3.

The cursor 242 is guided on a guide rail 630. The lift cable 234A includes an end 632 having a cable nipple 634. The end 632 and the nipple 634 are positioned within a housing portion 636 of the cursor 242. A helically wound compression spring 638 in the housing portion 363 biases the nipple 634 downwardly relative to the housing portion 636. The tensioning system effectively shortens the length of the lift cable 234A. The lowering cable 234B also includes an end 662 having a cable nipple 664 biased upwardly by the spring 668 to shorten the length of the lowering cable 234B. In further embodiments, the system used to shorten the cable need not be incorporated in the cursor 242.

The cursor 242 shown in FIG. 8 can be used as the cursor 342A of FIG. 4. The spring 638 provides a tensioning system for the lifting cable 397, and the spring 668 provides a tensioning system for the intermediate cable 399. The cursor 242 of FIG. 8 can also be used as the cursor 342B of FIG. 4. The spring 638 acts as a tensioning system for the intermediate cable 399, and the spring 668 acts as a tensioning system for the lowering cable 398.

It is generally advantageous to have a tensioning system for a lifting cable, a separate tensioning system for a lowering cable, and a further separate tensioning system for an intermediate cable (if one is present in the particular system). By using a cursor as shown in FIG. 8 for both the cursors 342A and 342B of FIG. 4, a tensioning system for the lifting cable, the lowering cable and the intermediate cable is provided. The system provides a tensioning spring at either end of the intermediate cable 399. In another embodiment, one of the springs that typically acts on the intermediate cable can be deleted to reduce costs.

All the embodiments described relate to vertically opening windows. However, the present invention is also applicable to horizontally opening closures. Thus, the terms “top”and “bottom” in the claims should not be regarded as limiting the claims to any particular position in space of one wheel to another.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A method for providing a window regulator cable assembly comprising the steps of:
mounting a cable drum wheel, a first top pulley wheel and a first bottom pulley wheel in a spaced apart relationship to form a subassembly;
mounting a cable arrangement to provide cable runs between the cable drum wheel, the top pulley wheel and the bottom pulley wheel, wherein at least one of the cable drum wheel, the top pulley wheel and the bottom pulley wheel is spaced from another of the cable drum wheel, the top pulley wheel and the bottom pulley wheel by at least one semi-rigid tube that surrounds an associated cable run, and the at least one semi-rigid tube is subject to an axial load to maintain tension in the cable arrangement; and
mounting the subassembly on a rigid frame to remove the axial load from the at least one semi-rigid tube.

2. The method as defined in claim 1 wherein the rigid frame is a vehicle door.

3. The method as defined in claim 1 further including the step of removing at least one semi-rigid tube after the step of mounting the subassembly on the rigid frame.

4. The method as defined in claim 1 wherein the at least one semi-rigid tube is made of an extruded plastic material.

5. The method as defined in claim 4 wherein the plastic material is selected from PVC and polyethylene.

6. The method as defined in claim 1 wherein the at least one semi-rigid tube is substantially straight.

7. The method as defined in claim 1 wherein the at least one semi-rigid tube includes a longitudinal slit that allows mounting of the at least one semi-rigid tube on the cable run and allows for removal of the at least one semi-rigid tube from the cable run.

8. The method as defined in claim 1 wherein the step of mounting the first top pulley and the second top pulley includes pivotally mounting the first top pulley wheel and the first bottom pulley wheel by a first top pivot and a first bottom pivot, respectively, wherein the first top pivot and the first bottom pivot are mounted on a first rigid member.

9. The method as defined in claim 8 further including a first semi-rigid tube mounted on the cable run between the cable drum wheel and first top pulley wheel and a second semi-rigid tube mounted on the cable run between the cable drum wheel and the first bottom pulley wheel.

10. The method as defined in claim 9 further including the steps of pivotally mounting a second top pulley wheel on a second top pivot and a second bottom pulley wheel on a second bottom pivot, and mounting the second top pivot and the second bottom pivot on a second rigid member spaced laterally from the first rigid member.

11. The method as defined in claim 10 wherein one of the cable runs between the first top pulley wheel and the second bottom pulley wheel include one of the semi-rigid tubes and wherein one of the cable runs between the second top pulley wheel and the first bottom pulley wheel includes one of the semi-rigid tubes.

12. The method as defined in claim 1 further including a plurality of cable runs and two cable runs of said plurality of cable runs intersect and at least one of the two cable runs includes one of the semi-rigid tubes to prevent contact between the two cable runs.

13. The method as defined in claim 1 further including the step of engaging a cable tensioning system having a resiliently mounted deflector on a portion of one of the cable runs to deflect said portion laterally and increase the effective length of the one of the cable runs.

14. The method as defined in claim 1 wherein the cable assembly further includes at least one cable defining a longitudinal direction and having an end mounted in a cable end housing, and the end is biased in the longitudinal direction by a resilient member to shorten the effective length of the cable to tension the cable arrangement.

15. A window regulator cable assembly comprising:
a cable drum wheel, a first top pulley wheel, and a first bottom pulley wheel in a spaced apart relationship;
a cable arrangement mounted on the cable drum wheel, the first top pulley wheel and the first bottom pulley wheel to form a plurality of cable runs between the cable drum wheel, the first top pulley wheel and the first bottom pulley wheel; and
a semi-rigid tube surrounding an associated cable run to temporarily space apart at least one of the cable drum wheel, the first top pulley wheel, and the first bottom pulley wheel from another of the cable drum wheel, the first top pulley wheel, and the first bottom pulley wheel to maintain an initial tension in the cable arrangement before assembly of the cable drum wheel, the first top pulley wheel, and the first bottom pulley wheel onto an associated rigid frame

16. The assembly as recited in claim 15 wherein the semi-rigid tube is made of a plastic material.

17. The assembly as recited in claim 16 wherein the plastic material is selected from PVC and polyethylene.

18. The assembly as recited in claim 15 wherein the semi-rigid tube includes a longitudinal slit that facilitates assembly of the semi-rigid tube on the associated cable run and facilitates removal of the semi-rigid tube from the associated cable rum.

19. The assembly as recited in claim 15 further including a second cable run that intersects the semi-rigid tube, and the semi-rigid tube prevents contact between the associated cable run and the second cable run.

20. The assembly as recited in claim 15 further including a cable tensioning system having a resiliently mounted deflector that engages a portion of one of the cable runs to deflect the portion laterally and increase an effective length of the one of the cable runs.

21. The assembly as recited in claim 15 further including at least one cable having an end defining a longitudinal direction and mounted in a cable end housing, and the cable end is biased in the longitudinal direction by a resilient member to shorten an effective length of the at least one cable to tension the cable arrangement.
